(19) United States
(12) Patent Application Publication
(10) Pub. No.: US 2014/0080537 A1
(43) Pub. Date: Mar. 20, 2014

(54) APPARATUS AND METHOD FOR BIASING POWER CONTROL TOWARDS EARLY DECODE SUCCESS

(71) Applicant: QUALCOMM INCORPORATED, San Diego, CA (US)

(72) Inventors: Prashant UDUPA SRIPATHI, San Jose, CA (US); Nate Chizgi, Sunnyvale, CA (US); Harish Venkatachari, Sunnyvale, CA (US); Shashank V. Maiya, Santa Clara, CA (US); Atul Arvind Salvekar, Emeryville, CA (US)

(73) Assignee: QUALCOMM Incorporated, San Diego, CA (US)

(21) Appl. No.: 13/889,997

(22) Filed: May 8, 2013

Related U.S. Application Data
(60) Provisional application No. 61/701,462, filed on Sep. 14, 2012.

(51) Int. Cl. H04W 52/24

(52) U.S. Cl. CPC H04W 52/241
USPC 455/522

(57) ABSTRACT

Disclosed are an apparatus and method for power control biasing towards early decode success of voice calls. In an aspect, the apparatus and method are configured to measure a signal-to-noise ratio (SNR) of a downlink transmission; request a base station to increase transmit power at the start of a transmission time interval (TTI) for a downlink voice call transmission; demodulate one or more voice frames of the voice call transmission; performing early decoding of one or more demodulated voice frames; determine whether the early decoding was successful; when the early decoding was successful, terminate demodulation and decoding of the voice call transmissions and request the base station to decrease transmit power; and when the early decoding was unsuccessful, request the base station to decrease transmit power for the remainder of the voice call transmission.

### CLAIM OF PRIORITY UNDER 35 U.S.C. §119

The present Application for Patent claims priority to Provisional Applications No. 61/701,462 entitled “Apparatus and Method for Biasing Power Control Towards Early Decode Success” and filed on Sep. 14, 2012, and assigned to the assignee hereof and hereby expressly incorporated by reference herein.

### BACKGROUND

1. Field

Aspects of the present disclosure relate generally to wireless communication systems, and more particularly, to an apparatus and method for power control biasing towards early decode success of voice calls.

2. Background

Wireless communication networks are widely deployed to provide various communication services such as telephony, video, data, messaging, broadcasts, and so on to user equipment (UE). Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (WCDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks. High Speed Downlink Packet Access (HSDPA) is a data service offered on the downlink of WCDMA networks.

Some wireless communication networks, such as WCDMA, provide early voice frame termination functionality by which a UE receiver attempts early decoding of voice transport channels. If the early decode of the voice channel is successful, the UE receiver may be transitioned into a low-power state to preserve battery power and a base station may reduce its transmit power also. Accordingly, there is a need for a mechanism for power control biasing towards early decode success of voice calls.

### SUMMARY

The following presents a simplified summary of one or more aspects of systems, methods and computer program products for power control biasing towards early decode success of voice calls. This summary is not an extensive overview of all contemplated aspects of the invention, and is intended to neither identify key or critical elements of the invention nor delineate the scope of any or all aspects thereof Its sole purpose is to present some concepts of one or more aspects in a simplified form as a prelude to the more detailed description that is presented later.

In one aspect, a method for power control biasing towards early decode success of voice calls includes measuring by UE a signal-to-noise ratio (SNR) of a downlink transmission. The method further includes requesting a base station to increase transmit power at the start of a transmission time interval (TTI) for a downlink voice call transmission. The method further includes demodulating one or more voice frames of the voice call transmission and performing early decoding of one or more demodulated voice frames. The method further includes determining whether the early decoding was successful. When the early decoding was successful, the method further includes terminating demodulation and decoding of the voice call transmissions and requesting the base station to decrease transmit power. When the early decoding was unsuccessful, the method further includes requesting the base station to decrease transmit power for the remainder of the voice call transmission.

In another aspect, an apparatus for power control biasing towards early decode success of voice calls includes a power control module configured to measure a SNR of a downlink transmission and request a base station to increase transmit power at the start of a TTI for a downlink voice call transmission. The apparatus further includes a demodulator configured to demodulate one or more voice frames of the voice call transmission. The apparatus further includes a decoder configured to perform early decoding of one or more demodulated voice frames and determine whether the early decoding was successful. When the early decoding was successful, the power control module further configured to terminate demodulation and decoding of the voice call transmissions and request the base station to decrease transmit power. When the early decoding was unsuccessful, the power control module further configured to request the base station to decrease its transmit power for the remainder of the voice call transmission.

In another aspect, an apparatus for power control biasing towards early decode success of voice calls includes means for measuring a SNR of a downlink transmission and means for requesting a base station to increase transmit power at the start of a TTI for a downlink voice call transmission. The apparatus further includes means for demodulating one or more voice frames of the voice call transmission and performing early decoding of one or more demodulated voice frames. The apparatus further includes means for determining whether the early decoding was successful. When the early decoding was successful, the apparatus further includes means for terminating demodulation and decoding of the voice call transmissions and requesting the base station to decrease its transmit power. When the early decoding was unsuccessful, the apparatus further includes means for requesting the base station to decrease its transmit power for the remainder of the voice call transmission.

In yet another aspect, a computer program product for power control biasing towards early decode success of voice calls comprises a computer-readable medium comprising code for measuring a SNR of a downlink transmission. The computer program product further includes code for requesting a base station to increase its transmit power at the start of a TTI for a downlink voice call transmission. The computer program product further includes code for demodulating one or more voice frames of the voice call transmission and performing early decoding of one or more demodulated voice frames. The computer program product further includes code for determining whether the early decoding was successful. When the early decoding was successful, the computer program product further includes code for terminating demodulation and decoding of the voice call transmissions and requesting the base station to decrease transmit power. When the early decoding was unsuccessful, the computer program product further includes code for requesting the base station to decrease its transmit power for the remainder of the voice call transmission.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example implementation of a RF receiver according to one aspect.

FIG. 2 is a diagram illustrating example of transmit power control command generation according to one aspect.

FIG. 3 is a diagram illustrating example of power control biasing towards early decode success according to one aspect.

FIG. 4 is a flow diagram illustrating an example methodology of power control biasing towards early decode success of voice calls according to one aspect.

FIG. 5 is a block diagram of an example electrical system for power control biasing towards early decode success according to one aspect.

FIG. 6 is a block diagram illustrating an example of a hardware implementation for an apparatus employing a processing system for performing power control biasing towards early decode success of voice calls according to one aspect.

FIG. 7 is a block diagram conceptually illustrating an example of a telecommunications system.

FIG. 8 is a conceptual diagram illustrating an example of an access network.

FIG. 9 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

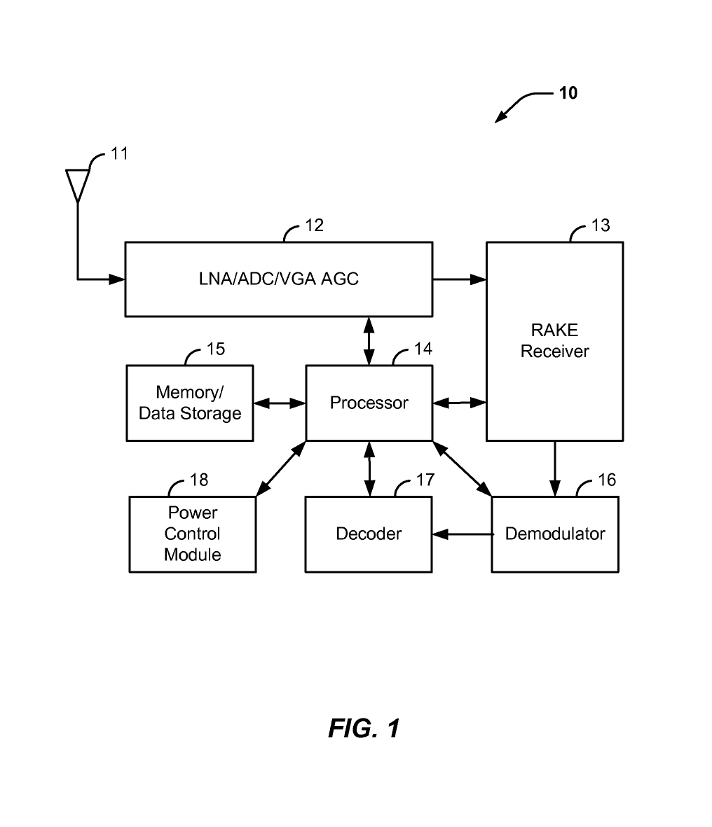

FIG. 1 illustrates an example configuration of a radio frequency (RF) receiver of a user equipment (UE). The RF receiver 10 includes a RF antenna 11 that receives RF signals, such as voice, data, and control frames on a downlink channel from a base station (e.g., Node B) and transforms them into electromagnetic signals for processing. The electromagnetic signals are transmitted to amplifier circuit 12, which may include a low noise amplifier (LNA), analog-to-digital converter (ADC), variable gain amplifier (VGA) and automatic gain control (AGC) circuit, which calibrates operating range of the LNA, ADC and VGA. The amplified and digitized signals are then passed to a Rake receiver 13, which is configured to mitigate the effects of the multipath fading. Rake receiver 13 may include a path search for identifying different propagation paths of the received signal, a channel estimator that estimate channel conditions, such as time delay, amplitude and phase for each path component, and a path combiner that combines strongest multipath components of the received signal into one signal. The resulting signal is then demodulated by the demodulator 16, such as a QPSK or QAM demodulator. The demodulated signal is passed to decoder 17, such as Viterbi decoder, which performs decoding of the convolutionally encoded data. The RF receiver 10 also includes a processor 14, such as a microprocessor or microcontroller, which executes programs for controlling operation of the components of the receiver 10, and memory 15 that stores runtime data and programs executable by the processor 14.

In WCDMA systems, voice calls may be encoded and transmitted in separate voice transport channels. For example, a WCDMA base station may use an Adaptive Multi Rate (AMR) coding scheme for processing voice calls by which voice data is encoded into three classes of data bits, e.g., classes A, B, and C, having different levels of importance. The AMR coded data is processed as three subflows (e.g., one subflow for each class of data) for a Dedicated Traffic Channel (DTCH) at the Radio Link Control (RLC) layer and sent on three separate voice transport channels (channels 1, 2 and 3, respectively for each class of data) at the Medium Access Control (MAC) layer. Each transport channel is associated with a transmission time interval (TTI) that may span one, two, four, or eight 10-millisecond (ms) slots.

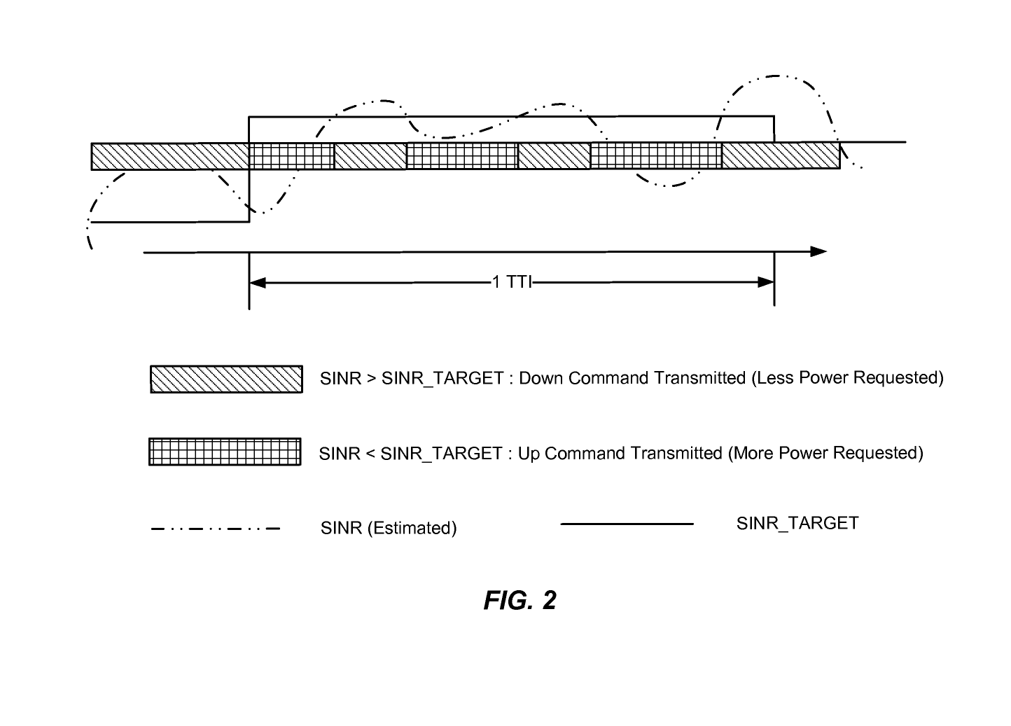

The WCDMA power control mechanism generally allows the UE to send in every TTI slot an Uplink (UL) transmit power control (TPC) command to the base station requesting to increase or decrease power at which voice signals are transmitted on the downlink (DL) transport channels. To determine whether to request more or less power from the base station, the UE can measure a Signal to Noise Ratio (SNR) or Signal to Interference plus Noise Ratio (SINR) from the common or dedicated pilots transmitted on the dedicated physical channel (DPCH) and compare the measured SINR (or SNR) to the desired SINR_TARGET needed to meet the block error rate (BLER) requirements set forth by the network. If SINR<SINR_TARGET, the UE can send an ULTPC UP command (1 bit) to the base station to request more power on the DL channel; and if SINR>SINR_TARGET, then the UE can send an ULTPC DOWN command (0 bit) to request less power on the DL channel. This algorithm is illustrated in the FIG. 2. In various aspects, the SINR_TARGET may be updated in the course of the TTI or at the end of the TTI in response to any cyclic redundancy check (CRC) status updates. The SINR_TARGET may be updated in a manner that the BLER targets set forth by the network are achieved. In another aspect an SNR and SNR_TARGET can be used for calculation of the appropriate TPC commands.

As explained above, some WCDMA systems provide early voice frame termination functionality by which early decoding of data on voice transport channels is attempted by the UE receiver 10, so that the receiver 10 may be transitioned into a low-power state to preserver UE batter power if the early decode of the received voice frames is deemed successful. Therefore, it is desirable to increase the rate of early decode success through biasing of power control towards the beginning of TTI. To that end, in one implementation, the UE receiver 10 includes a power control module 18 configured to request more power for the power control loop at the beginning of the TTI, e.g., first 10 ms of TTI, of the voice transport channels to improve early decode success, request less power later in the TTI to minimize network impact on average, and/or request less power later in the TTI in case of early decode success.

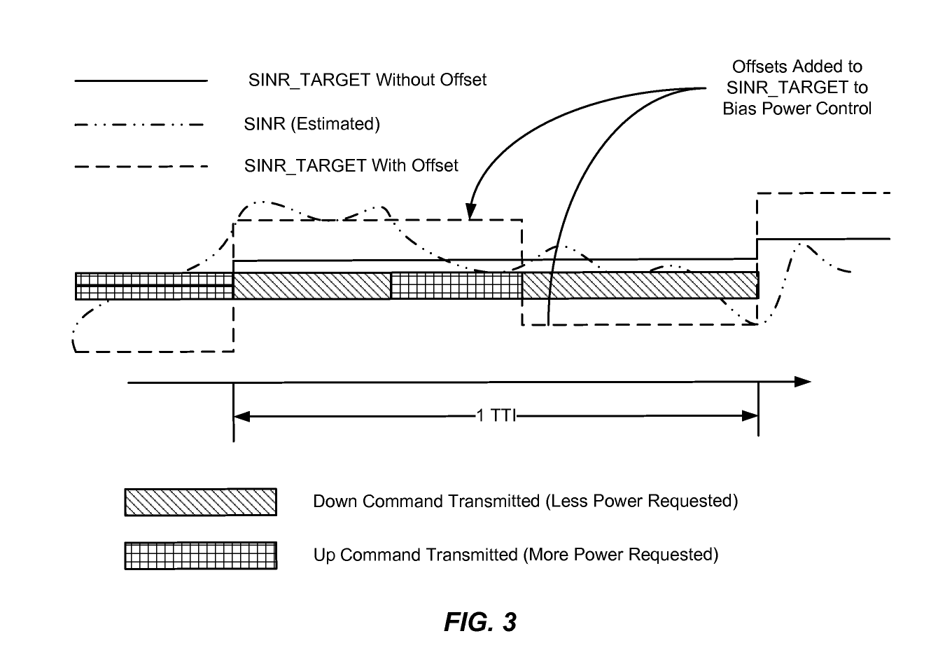

In one example implementation, the power control module 18 of the UE receiver 10 may be configured to implement a power control biasing algorithm illustrated in FIG. 3 to request the power control loop to bias more power at the start of a TTI and less power thereafter. As shown, the module 18 is configured to measure SINR (or SNR) at the beginning of the TTI, and in the first K1 slots of the TTI, generate a ULTPC DOWN command if SINR>SINR_TARGET+K2 and ULTPC UP command otherwise. Then, the UE receiver 10 may attempt early decode after K1 slots. In the rest of the TTI, if early decode was not successful, generate a ULTPC DOWN command if SINR>SINR_TARGET+K3 and ULTPC UP command otherwise. If early decode was successful, generate a ULTPC DOWN command if SINR>SINR_TARGET+K4 and ULTPC UP command otherwise. In an example aspect, value of K1=15 slots, and values of power offsets K2=1 dB, K3=−1 dB, and K4=−2 dB. These parameters may be optimized offline in a simulation environment or adaptively updated in the course of the voice call. In one aspect, power control module 18 may dynamically tune the biasing algorithm and biasing parameters over time in an adaptive manner to further optimize power control and improve early decode success rate.

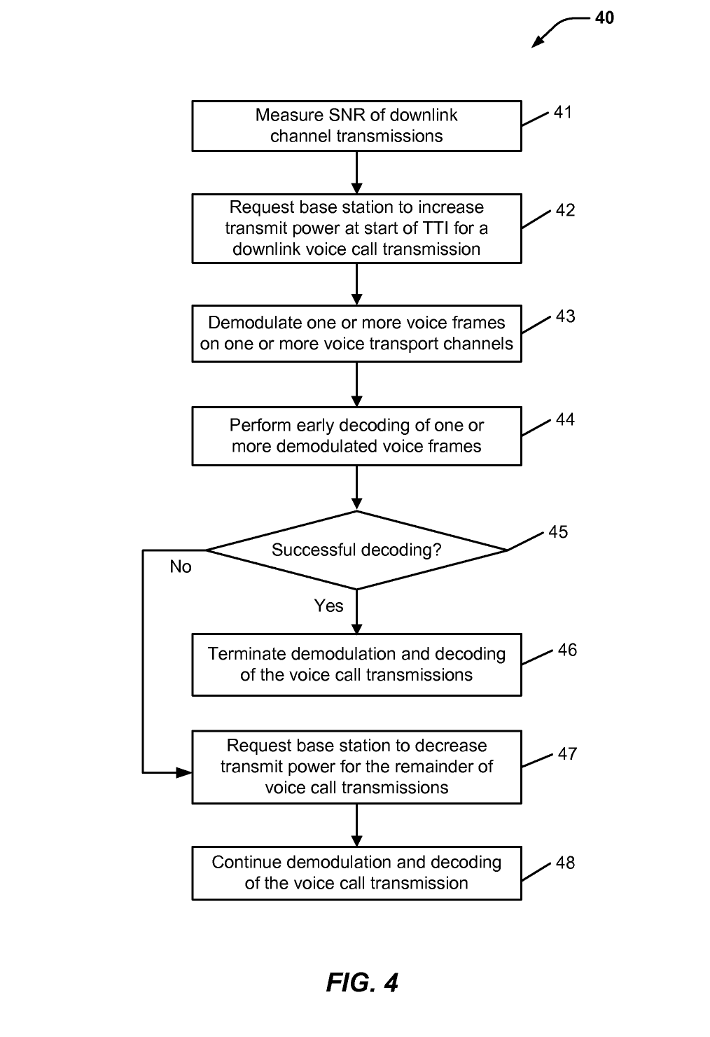

FIG. 4 is an example methodology of power control biasing towards early decode success of voice calls. In one aspect, the method 40 may be implemented in a UE receiver, such as receiver 10 of FIG. 1. At step 41, the method 40 includes measuring SINR of downlink channel transmissions. For example, in one example, the power control module 18 of the receiver 10 of FIG. 1 may be configured to measure SINR (or SNR) on the DL channel. At step 42, the method 40 includes requesting the base station to increase transmit power at start of TTI for a downlink voice call transmission. In one aspect, the power control module 18 of the receiver 10 may be configured to send an ULTPC UP command requesting the base station to increase its transmit power. At step 43, the method 40 includes demodulating one or more voice frames on one or more voice transport channels. In one aspect, the demodulator 16 of the UE receiver 10 may be configured to demodulate the received voice frames. At step 44, the method 40 includes performing early decode of one or more demodulated voice frames or parts of the frame. In one aspect, the decoder 17 of the UE receiver 10 may be configured to perform early decode of one or more voice frames or parts of a frame. At step 45, the method 40 includes determining if early decode was successful. In one aspect, the decoder 17 may be configured to determine if the early decode of the voice frame(s) or parts of the frame is successful, by for example performing a CRC or other known techniques. If the early decode was successful, at step 46, the method 40 includes terminating demodulation and decoding of the voice call transmissions and requesting the base station to decrease its transmit power. If the early decoding was unsuccessful, then at step 47, the method 40 includes requesting the base station to decrease its transmit power for the remainder of voice call transmission, and continuing at step 48, demodulation and decoding of the voice call transmissions at the reduced power. In one aspect, the power control module 18 may be configured to send an ULTPC DOWN command requesting the base station to decrease its transmit power based on determination by the decoder 17 whether the early decode of the voice frames was successful or unsuccessful.

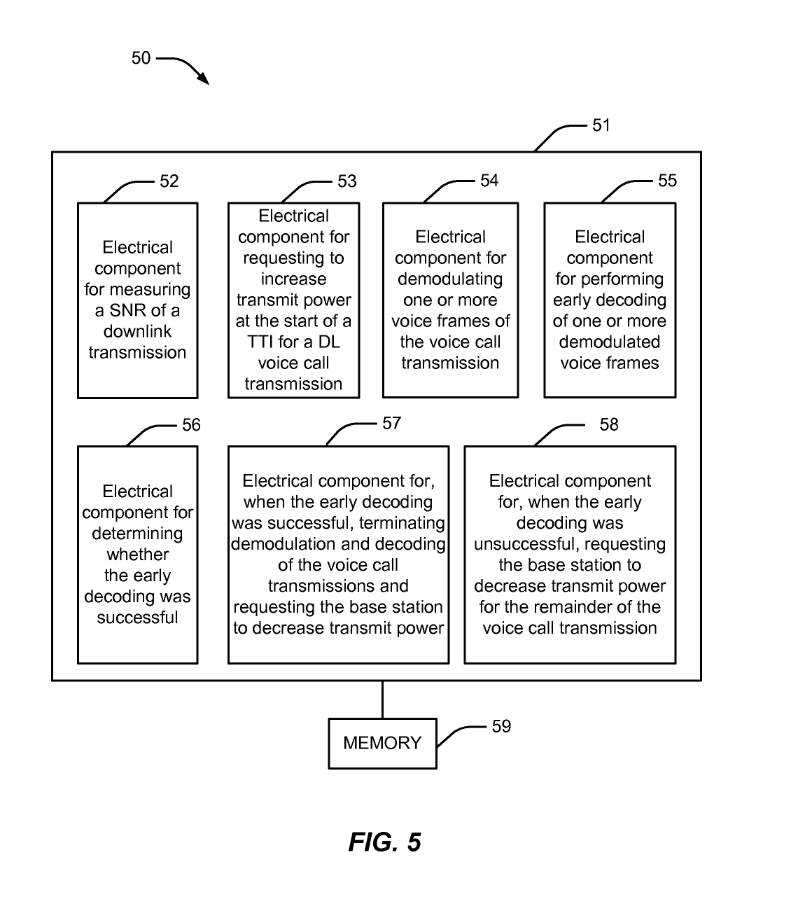

FIG. 5 illustrates an example electrical system 50 for power control biasing towards early decode success of voice calls according to aspects disclosed herein. The system 50 may be implemented in a RF receiver, such as UE receiver 10 of FIG. 1. It is to be appreciated that system 50 is represented as including functional blocks, which may correspond to the components of the UE receiver 10, implemented by a processor, software, or combination thereof (e.g., firmware). System 50 includes a logical grouping 51 of electrical components that can act in conjunction. For instance, logical grouping 51 can include an electrical component 52 for measuring a signal-to-noise ratio (SNR) of a downlink transmission. Moreover, logical grouping 51 can include an electrical component 53 for requesting to increase transmit power at the start of a TTI for a DL voice call transmission. Moreover, logical grouping 51 can include an electrical component 54 for demodulating one or more voice frames of the voice call transmission. Moreover, logical grouping 51 can include an electrical component 55 for performing early decoding of one or more demodulated voice frames. Moreover, logical grouping 51 can include an electrical component 56 for determining whether the early decoding was successful. Moreover, logical grouping 51 can include an electrical component 57 for, when the early decoding was successful, terminating demodulation and decoding of the voice call transmissions and requesting the base station to decrease transmit power. Moreover, logical grouping 51 can include an electrical component 58 for, when the early decoding was unsuccessful, requesting the base station to decrease transmit power for the remainder of the voice call transmission. Additionally, system 50 can include a memory 59 that retains instructions for executing functions associated with the electrical components 52-58, stores data used or obtained by the electrical components 52-58, etc. While shown as being external to memory 59, it is to be understood that one or more of the electrical components 52-58 can exist within memory 59. In one example, electrical components 52-58 can comprise at least one processor, or each electrical component 52-58 can be a corresponding module of at least one processor. Moreover, in an additional or alternative example, electrical components 52-58 can be a computer program product including a computer readable medium, where each of the electrical components 52-58 can be corresponding code.

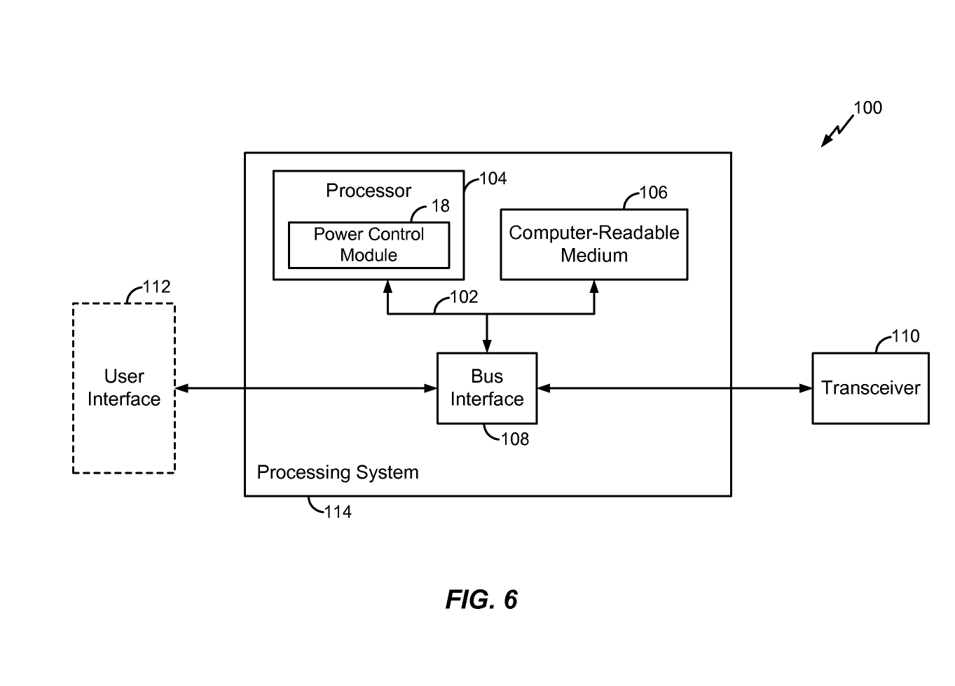

FIG. 6 is a block diagram illustrating an example of a hardware implementation for an apparatus 100, such as a UE, employing a processing system 114, such as a RF receiver 10 of FIG. 1. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. In one aspect, the processor 104 includes a power control module 18 that performs power control biasing towards early decode success of voice calls according to aspects disclosed herein. The computer-readable medium 106 may also be used for storing data that is manipulated by the processor 104 when executing software.

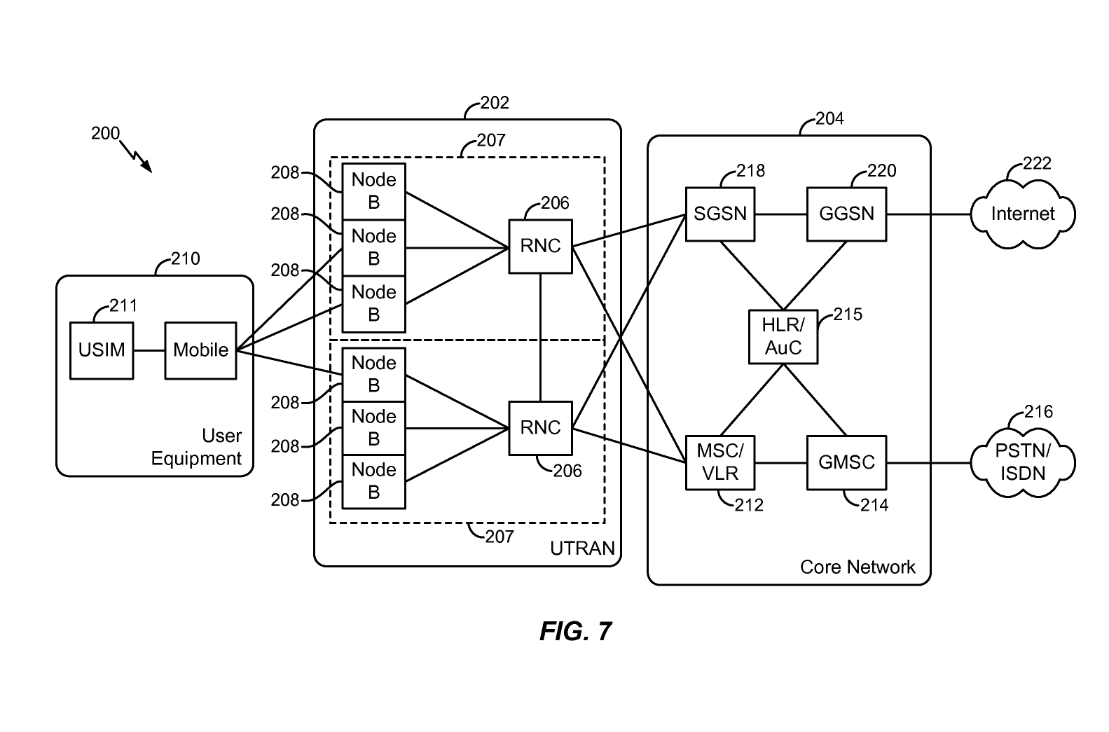

The systems and methods for performing power control biasing towards early decode success of voice calls according to various aspects presented throughout this disclosure may be implemented across a broad variety of telecommunication systems, network architectures, and communication standards. By way of example and without limitation, the aspects of the present disclosure illustrated in FIG. 7 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In one aspect, the UE 210 includes a RF receiver 10 of FIG. 1. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of UEs 210. Examples of a UE 210 include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE 210 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL). HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

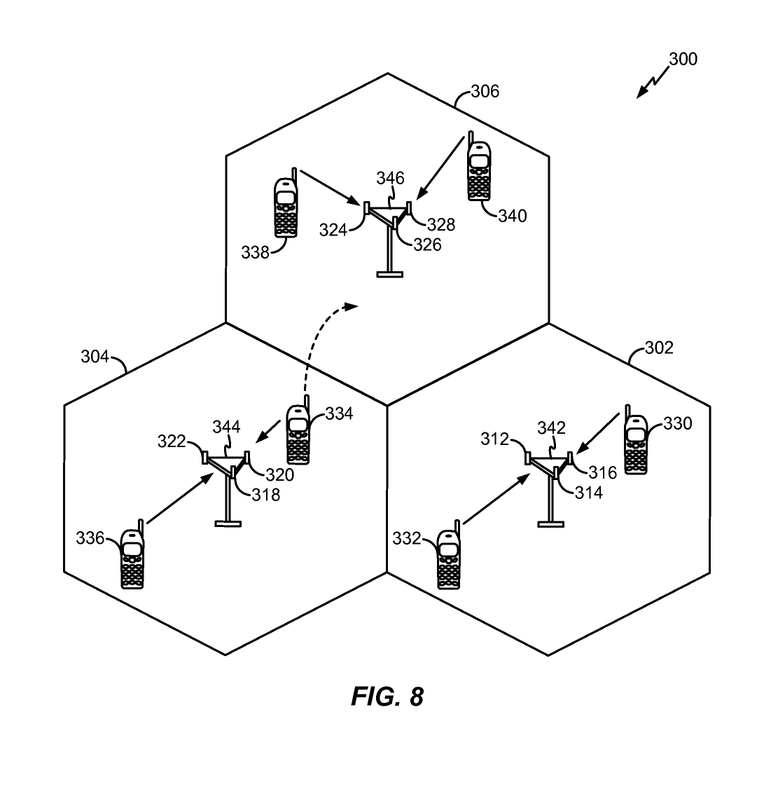

FIG. 8 illustrates an access network 300 in a UTRAN architecture in which various aspects of systems and methods for power control biasing towards early decode success of voice calls can be implemented. In particular, network 300 may include one or more UEs having RF receiver 10 of FIG. 1. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 7) for all the UEs 330, 332, 334, 336, 338, 340 in the respective cells 302, 304, and 306. In one aspect, the UEs 330, 332, 334, 336, 338, 340 may include RF receiver 10 of FIG. 1.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 7), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

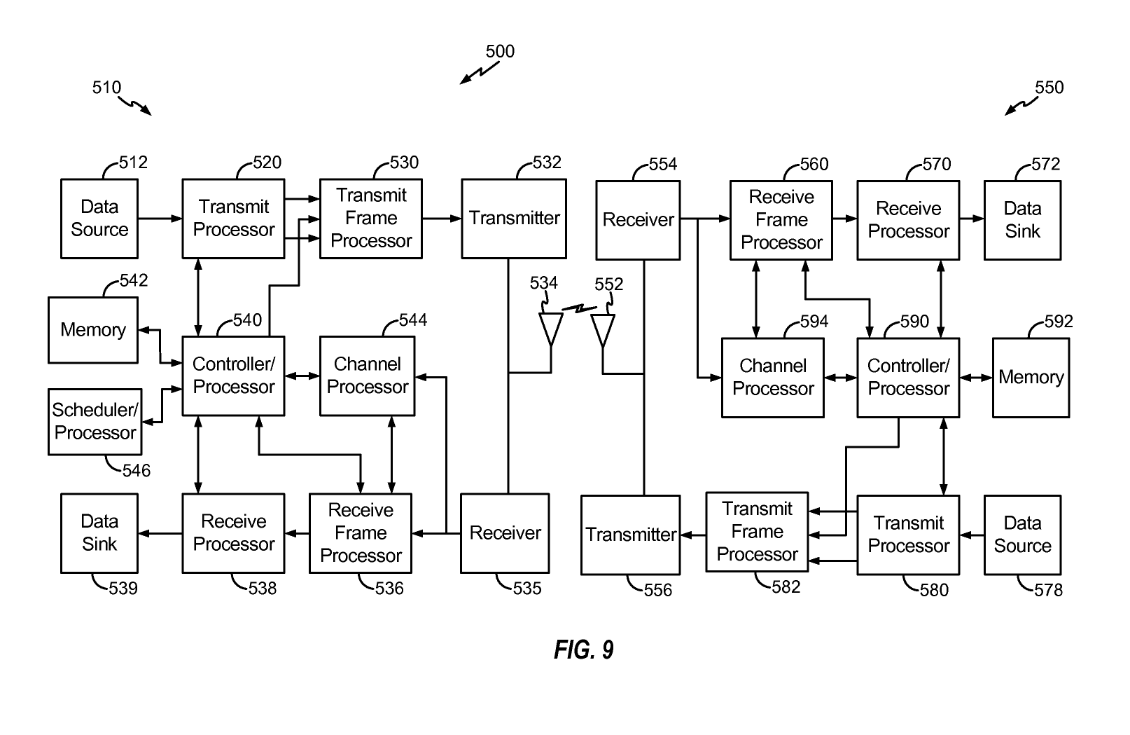

FIG. 9 is a block diagram of a Node B 510 in communication with a UE 550, where the Node B 510 may be the Node B 208 in FIG. 7, and the UE 550 may be the UE 210 in FIG. 7. In one aspect, the UE 550 includes a RF receiver 10 of FIG. 1. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, the method comprising:
measuring a signal-to-noise ratio (SNR) of a downlink transmission;
requesting a base station to increase transmit power at the start of a transmission time interval (TTI) for a downlink voice call transmission;
demodulating one or more voice frames of the voice call transmission;
performing early decoding of one or more demodulated voice frames;
determining whether the early decoding was successful;
when the early decoding was successful, terminating demodulation and decoding of the voice call transmissions and requesting the base station to decrease transmit power; and
when the early decoding was unsuccessful, requesting the base station to decrease transmit power for the remainder of the voice call transmission.

2. The method of claim 1, further comprising continuing demodulating and decoding the voice call transmission at reduced power.

3. The method of claim 1, wherein, when the early decoding was successful, requesting the base station to decrease transmit power to a level lower than the power level requested when the early decoding was unsuccessful.

4. The method of claim 1, wherein, when the early decoding was successful, further comprising requesting the base station to decrease transmit power when SNR is greater than a target SNR plus a first power offset.

5. The method of claim 4, wherein, when the early decoding was unsuccessful, further comprising requesting the base station to decrease transmit power when SNR is greater than a target SNR plus a second power offset, wherein the second power offset is higher than the first power offset.

6. The method of claim 1, wherein measuring a signal-to-noise ratio (SNR) includes measuring a signal to interference plus noise ratio (SINR).

7. An apparatus for wireless communication, comprising:
a power control module configured to measure a signal-to-noise ratio (SNR) of a downlink transmission and request a base station to increase transmit power at the start of a transmission time interval (TTI) for a downlink voice call transmission;
a demodulator configured to demodulate one or more voice frames of the voice call transmission;
a decoder configured to perform early decoding of one or more demodulated voice frames and determine whether the early decoding was successful; and
the power control module further configured to, when the early decoding was successful, terminate demodulation and decoding of the voice call transmissions and request the base station to decrease transmit power; and
the power control module further configured to, when the early decoding was unsuccessful, request the base station to decrease transmit power for the remainder of voice call transmission.

8. The apparatus of claim 7, wherein the demodulator and decoder further configured to continue demodulating and decoding the voice call transmission at reduced power.

9. The apparatus of claim 7, wherein, when the early decoding was successful, the power control module further configured to request the base station to decrease transmit power to a level lower than the power level requested when the early decoding was unsuccessful.

10. The apparatus of claim 7, wherein, when the early decoding was successful, the power control module further configured to request the base station to decrease transmit power when SNR is greater than a target SNR plus a first power offset.

11. The apparatus of claim 10, wherein, when the early decoding was unsuccessful, the power control module further configured to request the base station to decrease transmit power when SNR is greater than a target SNR plus a second power offset, wherein the second power offset is higher than the first power offset.

12. The apparatus of claim 7, wherein a signal-to-noise ratio (SNR) includes a signal to interference plus noise ratio (SINR).

13. An apparatus for wireless communication, comprising:
means for measuring a signal-to-noise ratio (SNR) of a downlink transmission;
means for requesting a base station to increase transmit power at the start of a transmission time interval (TTI) for a downlink voice call transmission;
means for demodulating one or more voice frames of the voice call transmission;
means for performing early decoding of one or more demodulated voice frames;
means for determining whether the early decoding was successful;
means for, when the early decoding was successful, terminating demodulation and decoding of the voice call transmissions and requesting the base station to decrease transmit power; and
means for, when the early decoding was unsuccessful, requesting the base station to decrease transmit power for the remainder of voice call transmission.

14. The apparatus of claim 13, further comprising means for continuing demodulating and decoding the voice call transmission at reduced power.

15. The apparatus of claim 13, further comprising means for, when the early decoding was successful, requesting the base station to decrease transmit power to a level lower than the power level requested when the early decoding was unsuccessful.

16. The apparatus of claim 13, further comprising means for, when the early decoding was successful, requesting the base station to decrease transmit power when SNR is greater than a target SNR plus a first power offset.

17. The apparatus of claim 16, further comprising means for, when the early decoding was unsuccessful, requesting the base station to decrease transmit power when SNR is greater than a target SNR plus a second power offset, wherein the second power offset is higher than the first power offset.

18. The apparatus of claim 13, wherein a signal-to-noise ratio (SNR) includes a signal to interference plus noise ratio (SINR).

19. A computer program product, comprising:
a computer-readable medium comprising code for:
measuring a signal-to-noise ratio (SNR) of a downlink transmission;
requesting a base station to increase transmit power at the start of a transmission time interval (TTI) for a downlink voice call transmission;
demodulating one or more voice frames of the voice call transmission;
performing early decoding of one or more demodulated voice frames;
determining whether the early decoding was successful;
when the early decoding was successful, terminating demodulation and decoding of the voice call transmissions and requesting the base station to decrease transmit power; and
when the early decoding was unsuccessful, requesting the base station to decrease transmit power for the remainder of voice call transmission.

20. The computer program product of claim 19, further comprising code for continuing demodulating and decoding the voice call transmission at reduced power.

21. The computer program product of claim 19, further comprising code for, when the early decoding was successful, requesting the base station to decrease transmit power to a level lower than the power level requested when the early decoding was unsuccessful.

22. The computer program product of claim 19, further comprising code for, when the early decoding was successful, requesting the base station to decrease transmit power when SNR is greater than a target SNR plus a first power offset.

23. The computer program product of claim 22, further comprising code for, when the early decoding was unsuccessful, requesting the base station to decrease transmit power when SNR is greater than a target SNR plus a second power offset, wherein the second power offset is higher than the first power offset.

24. The computer program product of claim 19, wherein the signal-to-noise ratio (SNR) includes a signal to interference plus noise ratio (SINR).
